(19) United States
(12) Patent Application Publication
(10) Pub. No.: US 2020/0067644 A1
(43) Pub. Date: Feb. 27, 2020

(54) DATA FEEDBACK METHOD AND RELATED DEVICE

(71) Applicant: HUAWEI TECHNOLOGIES CO., LTD., SHENZHEN (CN)

(72) Inventors: Fang NAN, Shenzhen (CN); Zheng YU, Beijing (CN)

(21) Appl. No.: 16/672,139

(22) Filed: Nov. 1, 2019

Related U.S. Application Data
(63) Continuation of application No. PCT/CN2017/083359, filed on May 5, 2017.

(51) Int. Cl. H04L 1/00; H04W 72/04; H04W 4/80; H04W 76/27

(52) U.S. Cl. CPC H04L 1/0073; H04W 72/042; H04W 76/27; H04L 1/0061; H04W 72/0466; H04W 4/80

(57) ABSTRACT

This application discloses an uplink data feedback method and a related device. The method includes: receiving uplink data from a terminal device; determining a first bit group of first downlink control information and a first bit in the first bit group, where bits of the first downlink control information constitute at least one bit group, bits included in each bit group of the first downlink control information are associated with one or more physical resource blocks in a narrowband, and the first bit is used to indicate whether the uplink data is correctly received, or to indicate whether new uplink data is sent by the terminal device; and sending the first downlink control information.

### CROSS-REFERENCE TO RELATED APPLICATIONS

This application is a continuation of International Application No. PCT/CN2017/083359, filed on May 5, 2017, the disclosure of which is hereby incorporated by reference in its entirety.

### TECHNICAL FIELD

This application relates to the field of wireless communications technologies, and in particular, to a data feedback method and a related device.

### BACKGROUND

In a wireless communications system such as long term evolution (LTE), to improve reliability of data transmission, a repeat request technology, such as a hybrid automatic repeat request (HARQ) mechanism, is used to transmit data. A base station may indicate resource allocation of uplink data for user equipment (UE) by using downlink control information (DCI) in a physical downlink control channel (PDCCH), and the UE transmits an uplink data packet based on the resource allocation. For an HARQ process, if an uplink data packet received by the base station is correct, and does not need to be retransmitted, the base station feeds back an acknowledgement (ACK) to the UE. Otherwise, the base station feeds back a negative acknowledgement (NACK) to indicate retransmission. The ACK or NACK feedback may be carried on a physical HARQ indicator channel (PHICH), so that data can be retransmitted when a current data transmission attempt fails. In addition, in machine type communication (MTC), various devices having particular perceptive, computing, execution, and communication capabilities are deployed to obtain information of the physical world, and information transmission, coordination, and processing are implemented by using a network, thereby implementing interconnections between people and things and between things and things. A maximum transmit bandwidth and a maximum receive bandwidth that can be supported by the UE in MTC are 1.4 MHz, including a narrowband. However, a frequency width occupied by the PDCCH and the PHICH in the LTE system may be an entire system bandwidth, and may be up to 20 MHz. When the receive bandwidth of the UE is less than the system bandwidth, the UE cannot receive the DCI carried on the PDCCH and the ACK or NACK carried on the PHICH.

Currently, to enable the UE to receive the DCI, a machine type communication physical downlink control channel (MPDCCH) is used to carry the DCI of the UE, and the DCI may include a 1-bit new data indicator (NDI) used to indicate whether the uplink data scheduled by using the DCI is newly sent data or previously sent data retransmitted in this process. If the NDI bit is reversed relative to an NDI bit in a DCI previously sent by the base station in this HARQ process, it indicates that the UE needs to send new uplink data; and if the NDI bit is not reversed, it indicates that the UE needs to retransmit data previously sent in this HARQ process. Consequently, an ACK or NACK feedback function that is of the base station and that indicates whether the uplink data is correctly received may be indicated by using the NDI bit in the DCI carried on the MPDCCH, so that the UE does not need to receive the ACK or NACK carried on the PHICH.

However, in the foregoing feedback manner, a DCI carried on each MPDCCH can only correspond to one UE. One piece of DCI can be used to feed back whether uplink data of only one HARQ process of one UE is correctly received. If whether uplink data of a plurality of UEs is correctly received needs to be fed back, the base station needs to send a plurality of pieces of DCI, which occupies a relatively large quantity of MPDCCH resources, and causes high resource overheads and relatively low feedback efficiency.

### SUMMARY

This application provides a data feedback method and a related device, so that feedback information of a plurality of pieces of uplink data can be carried by using one piece of downlink control information, helping resolve a problem of high overheads of feedback resources for feeding back whether the uplink data is correctly received and low feedback efficiency.

According to a first aspect, this application provides an uplink data feedback method, including:

receiving uplink data from a terminal device; determining a first bit group of first downlink control information and a first bit in the first bit group; and sending the first downlink control information.

Bits of the first downlink control information may include X bit groups. The bits of the first downlink control information constitute the X bit groups, and X is a positive integer. Further, the X bit groups include the first bit group, and one or more bits included in each of the X bit groups may be associated with one or more physical resource blocks in a narrowband in a system bandwidth. The first bit is used to indicate whether the uplink data is correctly received, or to indicate whether new uplink data is sent by the terminal device.

Optionally, the uplink data feedback method may be applied to an entity that receives uplink data and feeds back whether the uplink data is correctly received or whether new uplink data is sent, and the entity may be a network device, such as a base station or a terminal device. Further, optionally, the association relationship between the bit included in the bit group and the physical resource block in the narrowband may be obtained through pre-configuration, for example, agreed on by using a protocol. Alternatively, the network device may also notify a terminal device of the association relationship. For example, the network device may dynamically or semi-statically notify the terminal device by using signaling. Further, optionally, the first bit group may be notified by the network device to the terminal device. For example, the network device may dynamically or semi-statically notify, by using signaling, the terminal device of information used to indicate the first bit group. Alternatively, the association relationship between the bit group and the narrowband may be obtained through pre-configuration. For example, the association relationship between the bit group and the narrowband may be agreed on by using a protocol, and the first bit group is determined based on a narrowband occupied by the uplink data. This is not limited in this application. In this way, feedback information of a plurality of pieces of uplink data can be carried by using one piece of downlink control information, helping resolve a problem of high overheads of feedback resources for feeding back whether the uplink data is correctly received and low feedback efficiency.

In some embodiments, when determining the first bit in the first bit group, the network device may determine a physical resource block that is occupied by the uplink data and in a narrowband, and determine, in one or more bits included in the first bit group of the first downlink control information, the first bit associated with the physical resource block. The network device may determine, by determining the physical resource block that is occupied by the uplink data and in the narrowband and based on the physical resource block that is occupied by the uplink data and the association relationship between the one or more bits included in the bit group and the one or more physical resource blocks in the narrowband, a bit associated with the physical resource block occupied by the uplink data, and obtain, based on the determined first bit group, the associated bit in the first bit group as the first bit.

In some embodiments, when determining the first bit group of the first downlink control information, the network device may determine, based on a predefined association relationship between a bit group and a narrowband, a bit group associated with a narrowband in which a physical resource block occupied by the uplink data is located, and use the associated bit group as the first bit group.

In some embodiments, the network device may further determine a scrambling code of cyclic redundancy check (CRC) of the first downlink control information based on an index of the narrowband in which the physical resource block occupied by the uplink data is located, and scramble the CRC of the first downlink control information by using the scrambling code. Further, when sending the first downlink control information, the network device may send the scrambled first downlink control information.

In some embodiments, the network device may further send second downlink control information used to schedule the uplink data, where the second downlink control information may include at least one of indication information of the quantity X of the bit groups of the first downlink control information, information about the first bit group, or narrowband offset information. Further, the determining a first bit group of first downlink control information can be: determining the first bit group of the first downlink control information based on the second downlink control information.

Optionally, the second downlink control information may include the indication information of the quantity X of the bit groups of the first downlink control information and the information about the first bit group, so that the network device may determine, when determining the first bit group of the first downlink control information, the first bit group based on the indication information of the quantity X of the bit groups of the first downlink control information and the information about the first bit group. The information about the first bit group indicates the first bit group in all the bit groups in the first downlink control information, so that the network device may directly determine the first bit group.

Optionally, the second downlink control information may include the indication information of the quantity X of the bit groups of the first downlink control information and the narrowband offset information. In this way, the network device may determine, when determining the first bit group of the first downlink control information, the first bit group based on the indication information of the quantity X of the bit groups of the first downlink control information and the narrowband offset information.

In some embodiments, the network device may further send radio resource control (RRC) signaling, and send second downlink control information used to schedule the uplink data. The RRC signaling may include indication information of the quantity X of the bit groups of the first downlink control information, and the second downlink control information may include at least one of information about the first bit group and narrowband offset information. Further, when determining the first bit group of the first downlink control information, the network device may determine the first bit group of the first downlink control information based on the RRC signaling and/or the second downlink control information.

Optionally, the second downlink control information may include the information about the first bit group and/or the narrowband offset information. When a value of X indicated by the indication information of X included in the RRC signaling is greater than 1, it may indicate that the quantity of the bit groups included in the first downlink control information is greater than 1, and the quantity of the bit groups is the same as the value of X. In this way, when determining the first bit group, the network device may determine the first bit group based on the information about the first bit group, or determine the first bit group based on the narrowband offset information.

Optionally, when a value of X indicated by the indication information of X included in the RRC signaling is equal to 1, to be specific, when the quantity of the bit groups included in the first downlink control information is 1, bits included in the first downlink control information constitute the first bit group. Under this scenario, the second downlink control information may include the information about the first bit group and/or the narrowband offset information, so that the first bit group is determined based on the information about the first bit group and/or the narrowband offset information; or the second downlink control information may not include the information about the first bit group and the narrowband offset information, and the bits included in the first downlink control information are directly used as the first bit group.

In some embodiments, the network device may further determine a scrambling code of CRC of the first downlink control information based on an index of the narrowband in which the physical resource block occupied by the uplink data is located and the narrowband offset information, and scramble the CRC of the first downlink control information by using the scrambling code. Further, when sending the first downlink control information, the network device may send the scrambled first downlink control information.

In some embodiments, a quantity of bits included in the first bit is the same as a quantity of physical resource blocks occupied by the uplink data, and when the quantity of physical resource blocks occupied by the uplink data is greater than 1, the bits included in the first bit have a same value. In this way, reliability of data feedback can be improved.

According to a second aspect, this application further provides an uplink data feedback method, including:

sending uplink data; receiving first downlink control information from a network device; determining a first bit group of the first downlink control information and a first bit in the first bit group; and determining, based on the first bit, whether the uplink data is correctly received, or whether new uplink data is sent, where

Bits of the first downlink control information include X bit groups, and X is a positive integer. The X bit groups include the first bit group, and one or more bits included in each of the X bit groups may be associated with one or more physical resource blocks in a narrowband in a system bandwidth.

Optionally, the uplink data feedback method may be applied to an entity that sends uplink data. For example, the entity may be a terminal device.

In some embodiments, when determining the first bit in the first bit group, the terminal device may determine a physical resource block that is occupied by the uplink data and in a narrowband, and determine, in one or more bits included in the first bit group of the first downlink control information, the first bit associated with the physical resource block. The terminal device may determine, by determining the physical resource block that is occupied by the uplink data and in the narrowband and based on the association relationship between the bit included in the bit group and the physical resource block in the narrowband, a bit associated with the physical resource blocks occupied by the uplink data, and obtain, based on the determined first bit group, the associated bit in the first bit group as the first bit.

In some embodiments, when determining the first bit group of the first downlink control information, the terminal device may determine, based on a predefined association relationship between a bit group and a narrowband, a bit group associated with a narrowband in which a physical resource block occupied by the uplink data is located, and use the associated bit group as the first bit group.

In some embodiments, when receiving the first downlink control information from the network device, the terminal device may determine a scrambling code of CRC of the first downlink control information based on an index of the narrowband in which the physical resource block occupied by the uplink data is located, and descramble the CRC of the first downlink control information by using the scrambling code, to obtain the first downlink control information.

In some embodiments, the terminal device may further receive second downlink control information from the network device, where the second downlink control information is used to schedule the uplink data, and the second downlink control information includes at least one of indication information of the quantity X of the bit groups of the first downlink control information, information about the first bit group, or narrowband offset information. Further, when determining the first bit group of the first downlink control information, the terminal device may determine the first bit group of the first downlink control information based on the second downlink control information.

In some embodiments, the terminal device may further receive RRC signaling from the network device, and receive second downlink control information from the network device, where the RRC signaling may include indication information of the quantity X of the bit groups of the first downlink control information, the second downlink control information is used to schedule the uplink data, and the second downlink control information may include at least one of information about the first bit group and narrowband offset information. Further, when determining the first bit group of the first downlink control information, the terminal device may determine the first bit group of the first downlink control information based on the RRC signaling and/or the second downlink control information.

In some embodiments, when receiving the first downlink control information from the network device, the terminal device may determine a scrambling code of CRC of the first downlink control information based on an index of the narrowband in which the physical resource block occupied by the uplink data is located and the narrowband offset information, and descramble the CRC of the first downlink control information by using the scrambling code, to obtain the first downlink control information.

In some embodiments, a quantity of bits included in the first bit is the same as a quantity of physical resource blocks occupied by the uplink data, and when the quantity of physical resource blocks occupied by the uplink data is greater than 1, the bits included in the first bit have a same value. In this way, reliability of data feedback can be improved.

According to a third aspect, this application further provides a network device. The network device includes: a transceiver unit and a processing unit. The network device implements some or all of the operations in the foregoing feedback method for uplink data according to the first aspect by using the foregoing units.

According to a fourth aspect, this application further provides a terminal device. The terminal device includes: a transceiver unit and a processing unit. The terminal device implements some or all of the operations in the foregoing feedback method for uplink data according to the second aspect by using the foregoing units.

According to a fifth aspect, this application further provides a computer storage medium. The computer storage medium stores a program, and when the program is executed, some or all of the operations in the foregoing feedback method for uplink data according to the first aspect are performed.

According to a sixth aspect, this application further provides a computer storage medium. The computer storage medium stores a program, and when the program is executed, some or all of the operations in the foregoing feedback method for uplink data according to the second aspect are performed.

According to a seventh aspect, this application further provides a network device. The network device includes: a transceiver and a processor. The processor is connected to the transceiver, and the transceiver is configured to perform some or all of the operations in the foregoing feedback method for uplink data according to the first aspect.

According to an eighth aspect, this application further provides a terminal device. The terminal device includes a transceiver and a processor. The processor is connected to the transceiver, and the transceiver is configured to perform some or all of the operations in the foregoing feedback method for uplink data according to the second aspect.

According to a ninth aspect, this application further provides an uplink data feedback system, including a network device and a terminal device. The network device is configured to perform some or all of the operations in the foregoing feedback method for uplink data according to the first aspect; and the terminal device is configured to perform some or all of the operations in the foregoing feedback method for uplink data according to the second aspect.

According to a tenth aspect, this application further provides a computer program product including an instruction. When the computer program product is run on a computer, the computer is enabled to perform the methods according to all the foregoing aspects.

In the technical solutions claimed in this application, the terminal device may send the uplink data to the network device. The network device may determine the first bit group in the first DCI and the first bit in the first bit group after receiving the uplink data, and the first bit is used to indicate whether the uplink data is correctly received, or whether the new uplink data is sent. After receiving the first DCI, the terminal device may determine, as indicated by the first bit, whether to retransmit the data, so that feedback information of a plurality of pieces of uplink data can be carried by using one piece of DCI, helping resolve a problem of high overheads of feedback resources for feeding back whether the uplink data is correctly received and low feedback efficiency.

### BRIEF DESCRIPTION OF DRAWINGS

FIG. 1 is an architectural diagram of a communications system according to an embodiment of the present disclosure;

FIG. 2a is a schematic diagram of a first bit group and a first bit according to an embodiment of the present disclosure;

FIG. 2b is a schematic diagram of an association relationship between a bit in a bit group and a physical resource block (PRB) in a narrowband according to an embodiment of the present disclosure;

FIG. 3 is a schematic interactive diagram of an uplink data feedback method according to an embodiment of the present disclosure;

FIG. 4 is a schematic interactive diagram of another feedback method for uplink data according to an embodiment of the present disclosure;

FIG. 5a is a schematic diagram of an association relationship between a bit group and a narrowband according to an embodiment of the present disclosure;

FIG. 5b is a schematic diagram of another association relationship between a bit group and a narrowband according to an embodiment of the present disclosure;

FIG. 6 is a schematic interactive diagram of still another feedback method for uplink data according to an embodiment of the present disclosure;

FIG. 7 is a schematic interactive diagram of still another feedback method for uplink data according to an embodiment of the present disclosure;

FIG. 8 is a schematic diagram of still another association relationship between a bit group and a narrowband according to an embodiment of the present disclosure.

FIG. 9 is a schematic structural diagram of a network device according to an embodiment of the present disclosure;

FIG. 10 is a schematic structural diagram of a terminal device according to an embodiment of the present disclosure;

FIG. 11 is a schematic structural diagram of an uplink data feedback system according to an embodiment of the present disclosure;

FIG. 12 is a schematic structural diagram of another network device according to an embodiment of the present disclosure; and

FIG. 13 is a schematic structural diagram of another terminal device according to an embodiment of the present disclosure.

### DESCRIPTION OF EMBODIMENTS

The following describes the embodiments of the present disclosure with reference to the accompanying drawings in the embodiments of the present disclosure.

The technical solutions of this application may be applied to various communication networks, such as: a global system for mobile communications (GSM), a code division multiple access (CDMA) system, a wideband code division multiple access (WCDMA) system, a time division-synchronous code division multiple access (TD-SCDMA) system, a universal mobile telecommunications system (UMTS), a long term evolution (LTE) network and the like. With continuous development of communication technologies, the technical solutions of this application may further be applied to a future network, such as a fifth generation mobile communication technology (5G) network, which may be referred to as a new radio (NR) network, or may be applied to a device-to-device (D2D) network, a machine-to-machine (M2M) network, and the like.

A network device related to this application may be an entity configured to send or receive a signal on a network side. For example, the network device may be a base station, or may be a transmission point (TP), a transmission and receiver point (TRP), a relay device, or another network device having a function of a base station, or a terminal device. Communication related in the technical solutions of this application may be between a base station and a terminal device, or may be between a terminal device and a terminal device, such as communication in a D2D network. Alternatively, the technical solutions of this application may be applied to another scenario, for example, any scenario in which an entity sends uplink data, and another entity receives the uplink data and feeds back whether the uplink data is correctly received.

In this application, the terminal device may also be referred to as user equipment (UE), a mobile station (MS), a terminal, a mobile terminal, a subscriber unit (SU), a subscriber station (SS), a mobile station (MS), a remote station (RS), an access point (AP), a remote terminal (RT), an access terminal (AT), a user terminal (UT), a user agent (UA), a terminal device (user device, UD), and the like. This is not limited in this application. The terminal may be a wireless terminal or a wired terminal. The wireless terminal may be a device providing voice and/or data connectivity for a user, and may communicate with one or more core networks through a radio access network. For example, the terminal device may be UE that performs an MTC service, bandwidth-reduced low-complexity (BL) UE, non-BL UE, a coverage enhancement (CE) UE, or the like.

In this application, a base station may be a device communicating, on an air interface in an access network, with a terminal by using one or more sectors, and may coordinate attribute management for the air interface. For example, the base station may be a base station, such as a base transceiver station (BTS), in GSM or CDMA; or a base station, such as a NodeB, in WCDMA; or an evolved NodeB, such as an evolutional Node B (eNB or e-NodeB), in LTE; or a base station, such as a gNB, in a 5G system; or a base station in a future network. This is not limited in application.

In this application, signaling related in embodiments of this application may be high layer signaling, such as a system message, or a broadcast message, or radio resource control (RRC) signaling, or medium access control (MAC) signaling. Optionally, the signaling may alternatively be physical layer signaling, such as downlink control information (DCI) signaling. This is not limited in this application.

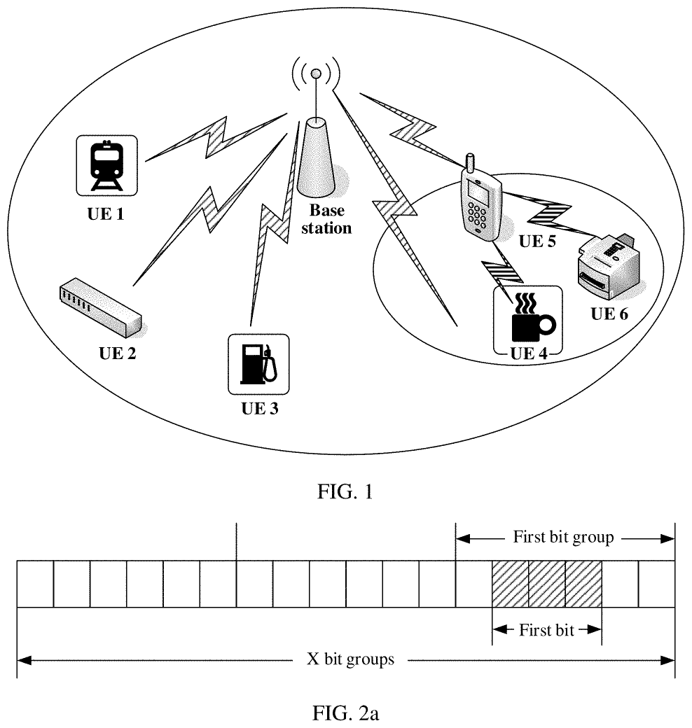

An application scenario of this application is described in the following. In this application, that the network device is a base station is used as an example, to be specific, communication between the base station and a terminal device is used as an example for description. FIG. 1 is an architectural diagram of a communications system according to an embodiment of the present disclosure. As shown in FIG. 1, the communications system includes a base station and terminal devices (UE 1 to UE 6 are shown in the figure), various communications systems, such as the 5G system, which may be referred to as an NR system, or the LTE system in the foregoing wireless communications systems, may be used for communication between the base station and the terminals, or between the terminals, to implement information transmission.

For example, in the communications system, the UE 1 to the UE 6 may send uplink data to the base station, and the base station receives the uplink data sent by the UE 1 to the UE 6, and may feed back, to corresponding UEs, whether the uplink data is correctly received or whether new uplink data needs to be sent. In addition, the UE 4 to the UE 6 may also constitute a communications system. For another example, in the communications system, the UE 4 and the UE 6 may send uplink data to the UE 5, and the UE 5 receives the uplink data sent by the UE 4 and the UE 6, and may feed back, to the UE 4 and the UE 6 in a particular manner, whether the uplink data is correctly received or whether new uplink data needs to be sent.

In this application, when giving the feedback, the terminal device may implement the feedback by using downlink control information such as DCI, and the downlink control information may be carried on a control channel. The control channel related in this application is mainly configured to carry resource scheduling information and other control information. For example, the control channel may be a physical downlink control channel (PDCCH), an enhanced physical downlink control channel (EPDCCH), a new radio physical downlink control channel (NR-PDCCH), a machine type communication physical downlink control channel (MPDCCH), or another control channel that is defined as the network evolves and that has the foregoing function. In this application, that the downlink control information is DCI, and the control channel is an MPDCCH is used as an example, to be specific, that the MPDCCH carries the DCI is used as an example for description. In this application, the channel may also be referred to as a signal or another name. This is not limited in this application.

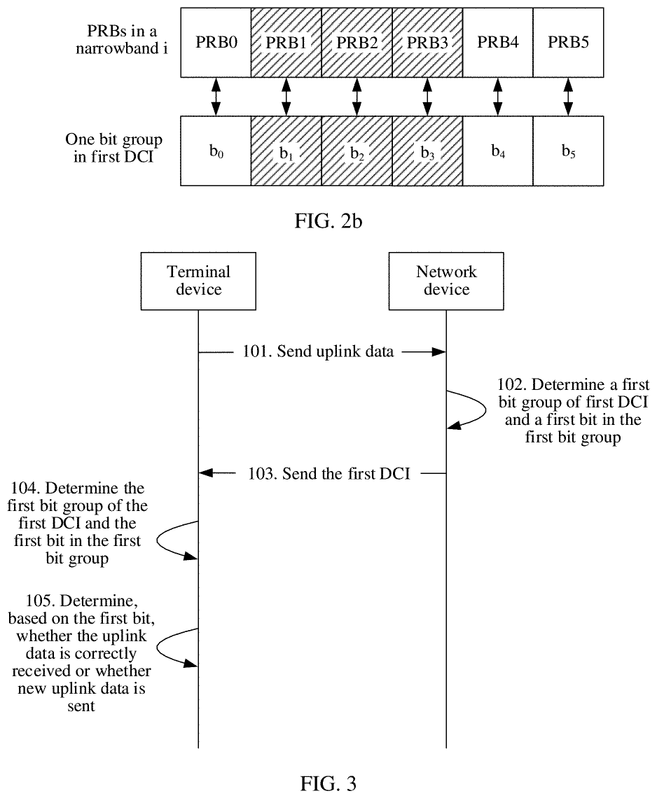

Optionally, the DCI used for feedback, namely, first DCI, may include a plurality of bit groups, for example, X bit groups, and each bit group may include one or more bits, so that the base station can feed back, based on the one or more bits of each bit group, whether the uplink data is correctly received or whether new uplink data needs to be sent. X is an integer greater than or equal to 1. Further, it is assumed that one or more bits used for feedback is a first bit. FIG. 2a is a schematic diagram of X bit groups constituted by bits of the first DCI and a first bit in a first bit group. Optionally, the first bit may include one or more bits.

For example, the first bit used for feedback may indicate an ACK or NACK (to indicate whether the data is correctly received). If a value of the first bit is 1 (or 0), the first bit indicates an ACK, to be specific, the base station correctly receives the uplink data sent by the terminal device; or if a value of the first bit is 0 (or 1), the first bit indicates an NACK, to be specific, the base station does not correctly receive the uplink data. For another example, the first bit may alternatively be an NDI (indicating whether new uplink data needs to be sent). For example, if the value of the first bit is reversed relative to a value of an NDI bit in DCI that is previously sent by the base station in this HARQ process and that is used to schedule the uplink data, namely, a second DCI, it indicates that the terminal device may send new uplink data; or if the value of the first bit is not reversed, it indicates that the terminal device needs to retransmit the uplink data previously sent in this HARQ process, to be specific, perform data retransmission.

The uplink data can be carried on a physical uplink shared channel (PUSCH). A narrowband may include 6 continuous physical resource blocks (PRB) on frequency. Resources occupied by the uplink data may use a PRB as a resource unit, and the PRB occupied by the uplink data may be a PRB in a frequency range of a narrowband. Optionally, the resources occupied by the uplink data may alternatively use another resource unit. Alternatively, a narrowband may include another quantity of PRBs. This is not limited in this application.

Further, an association relationship between a PRB in a narrowband and a bit in a bit group may be preconfigured. For example, the PRB in the narrowband and the bit in the bit group may have a one-to-one association relationship. For example, FIG. 2b is a schematic diagram of an association relationship between a bit in a bit group and a PRB in a narrowband. FIG. 2b illustrates an association relationship between a bit in a bit group of the first DCI and a PRB in a narrowband such as a narrowband i. Optionally, narrowbands within a frequency range of a system bandwidth may be numbered as narrowband indexes in ascending order or descending order of frequency. Assuming that a quantity of narrowbands included in the frequency range of the system bandwidth is N_{NB}, a value range of the narrowband index may be 0 to N_{NB}−1. For example, the narrowband i may represent a narrowband having an index of i. PRBs within a narrowband are PRBs included in a frequency range of the narrowband, and 6 continuous PRBs included in a narrowband in terms of frequency may be numbered as PRB indexes within the narrowband in ascending order or descending order of frequency, and a value range of the PRB index is 0 to 5. For example, PRBj indicates a PRB having an index of j. As shown in FIG. 2b, 6 bits b₀, b₁, b₂, b₃, b₄, b₅ included in a bit group in the first DCI may be respectively associated with 6 PRBs in the narrowband i: a PRB 0, a PRB 1, a PRB 2, a PRB 3, a PRB 4, a PRB 5, and a PRB 6. Further, optionally, bits included in different bit groups of the first DCI may be associated with PRBs in different narrowbands. Each bit group in the first DCI may be associated with one narrowband, and different bit groups of the first DCI may be associated with different narrowbands.

As shown in shaded parts in FIG. 2b, it is assumed that PRB indexes of PRBs of a PUSCH in the narrowband i are 1, 2, and 3, and positions of the PRBs in the narrowband are the second PRB, the third PRB, and the fourth PRB starting from a PRB with a relatively low frequency. If the network device determines that the indexes of the PRBs are 1, 2 and 3, bits b₁, b₂, b₃ in the first bit group in the first DCI may be determined as the first bit based on an association relationship between the bits b₁, b₂, b₃ in the first bit group in the first DCI and the PRBs having the indexes of 1, 2 and 3. Alternatively, if the network device determines the second PRB, the third PRB, and the fourth PRB starting from the PRB with the relatively low frequency, the network device may determine bits b₁, b₂, b₃ in the first bit group in the first DCI as the first bit based on an association relationship between the second PRB, the third PRB, and the fourth PRB and the bits b₁, b₂, b₃ in the first bit group in the first DCI.

Optionally, a quantity of the bits included in the first bit may be the same as a quantity of PRBs of a PUSCH that carries the uplink data. Further, optionally, when the quantity N of the PRBs of the PUSCH that carries the uplink data is greater than 1, the first bit includes N bits, and values of the N bits may be the same, to improve reliability of data feedback. As shown in FIG. 2b, when there are three PRBs, namely, the PRB 1, the PRB 2, and the PRB 3, of the PUSCH that carries the uplink data, the first bit includes 3 bits, namely, b₁, b₂, b₃, and the 3 bits have a same value. In this application, the manner for determining the PRB indexes and the narrowband indexes may alternatively be another manner. This is not limited in this application.

This application discloses an uplink data feedback method, a network device, a terminal device, and a system, so that feedback information of a plurality of pieces of uplink data can be carried by using one piece of DCI, helping resolve a problem of high overheads of feedback resources for feeding back whether the uplink data is correctly received and low feedback efficiency. Detailed descriptions are separately provided below in detail.

FIG. 3 is a schematic interactive diagram of an uplink data feedback method according to an embodiment of the present disclosure. As shown in FIG. 3, the uplink data feedback method according to this embodiment of the present disclosure may include the following operations.

101: A terminal device sends uplink data to a network device.

102: The network device determines a first bit group in first DCI and a first bit in the first bit group.

Bits of the first DCI constitute at least one bit group. For example, the bits of the first DCI include X bit groups, and X is a positive integer. One or more bits included in each of the X bit groups are associated with one or more PRBs in a narrowband in a system bandwidth, and the first bit is used to indicate whether the uplink data is correctly received, or to indicate whether new uplink data is sent by the terminal device. The network device may receive the uplink data sent by the terminal device, to determine a feedback bit group (namely, the first bit group) and a feedback bit (namely, the first bit in the first bit group) in DCI (namely, the first DCI) that is used to feed back whether the uplink data is correctly received or whether the terminal device needs to send the new uplink data.

Optionally, an association relationship between a bit included in a bit group and a PRB in a narrowband may be obtained through pre-configuration. For example, the association relationship between the bit included in the bit group and the PRB in the narrowband may be shown in FIG. 2b, and details are not described herein again. Further, Optionally, each bit group in the first DCI may be associated with one narrowband, and different bit groups of the first DCI may be associated with different narrowbands. In this way, by determining the PRB occupied by the uplink data, to be specific, a position of the PRB that carries the uplink data sent by the terminal device and that is in the narrowband, the network device can determine, based on the association relationship between the bit included in the bit group and the PRB in the narrowband, a bit that is in the bit group and associated with the PRB occupied by the uplink data, and then obtain, based on the determined first bit group, the associated bit in the first bit group as the first bit.

Information about the PRB occupied by the uplink data may be notified to the terminal device by the network device. For example, the network device may send, to the terminal device through scheduling DCI (namely, second DCI), information of a PUSCH resource, such as a PRB, occupied by the uplink data. Optionally, the first bit group used to give data feedback may be notified to the terminal device by the network device. For example, the network device may dynamically or semi-statically notify the terminal device by using signaling. Alternatively, the first bit group may be predefined. For example, an association relationship between the bit group and the narrowband may be predefined, and the first bit group is determined based on a narrowband occupied by the uplink data. This is not limited in this embodiment of the present disclosure.

103: The network device sends the first DCI.

104: The terminal device determines the first bit group in the first DCI and the first bit in the first bit group.

Optionally, after determining the first bit group and the first bit, the network device may further scramble cyclic redundancy check (CRC) of the first DCI by using a scrambling code determined in a preset manner, and send the scrambled first DCI to ensure that the terminal device that sends the uplink data can receive the first DCI. The scrambling code for scrambling may be determined based on a position of a narrowband in which the PRB occupied by the uplink data is located, for example, based on an index of the narrowband or based on the index of the narrowband and narrowband offset information. This is not limited in this embodiment of the present disclosure.

Further, optionally, the terminal device may descramble, by using the scrambling code determined in a preset manner, the CRC of the DCI sent by the base station, to obtain the first DCI. The manner of determining, by the terminal device, the scrambling code for descrambling may be the same as the manner of determining, by the network device, the scrambling code for scrambling.

Further, after obtaining the first DCI, the terminal device may determine the first bit group of the first DCI and the first bit. A manner of determining, by the terminal device, the first bit group and the first bit may be the same as a manner of determining, by the network device, the first bit group and the first bit. Details are not described herein again.

105: The terminal device determines, based on the first bit, whether the uplink data is correctly received or whether new uplink data is sent.

After determining the first bit, the terminal device may determine, based on feedback information indicated by the first bit, whether the uplink data is correctly received or whether the new uplink data is sent. The first bit may indicate an ACK or NACK by using 0 or 1 or by using an NDI. For details, refer to the foregoing related descriptions, and details are not described herein again.

In this embodiment of the present disclosure, the terminal device may send the uplink data to the network device. The network device may determine the first bit group in the first DCI and the first bit in the first bit group after receiving the uplink data, and the first bit is used to indicate whether the uplink data is correctly received, or whether the new uplink data is sent. After receiving the first DCI, the terminal device may determine, as indicated by the first bit, whether to retransmit the data, so that feedback information of a plurality of pieces of uplink data can be carried by using one piece of DCI, helping resolve a problem of high overheads of feedback resources for feeding back whether the uplink data is correctly received and low feedback efficiency.

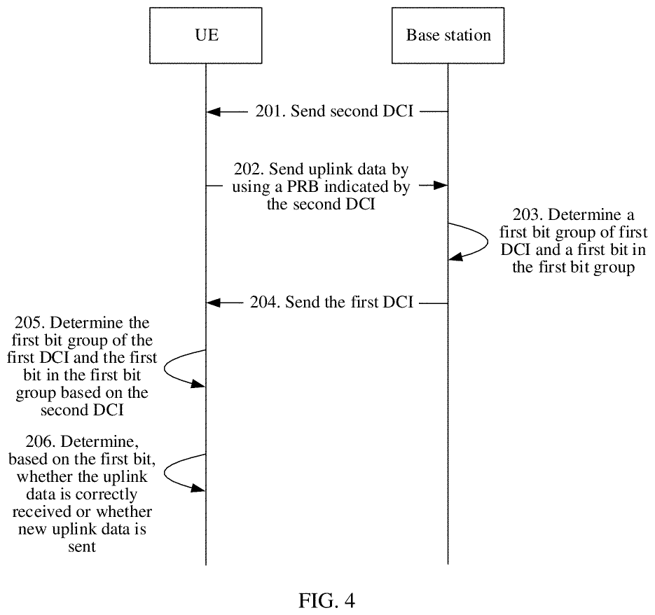

FIG. 4 is a schematic interactive diagram of another feedback method for uplink data according to an embodiment of the present disclosure. In this embodiment of the present disclosure, an example in which the network device is a base station, to be specific, communication between the base station and UE, is used for description. As shown in FIG. 4, the uplink data feedback method according to this embodiment of the present disclosure may include the following operations.

201: A base station sends second DCI, where the second DCI includes at least one of information about a PRB carrying uplink data of the UE, indication information of a quantity X of bit groups in first DCI, information about a first bit group, or narrowband offset information.

202: The UE sends the uplink data to the base station by using the PRB indicated by the second DCI.

The second DCI may be used to schedule the uplink data, and the second DCI may include resource allocation, such as PRB information and a modulation and coding scheme, of a PUSCH carrying the uplink data. The PRB information may include a PRB index, and may further include an index of a narrowband in which the PRB is located. The PRB information may be used to indicate a specific position of the PRB carrying the uplink data. In this way, the UE may determine, based on the second DCI, the PRB carrying the uplink data, and transmit the uplink data by using the PRB.

203: The base station determines a first bit group in first DCI and a first bit in the first bit group.

Bits of the first DCI constitute at least one bit group, and one or more bits included in each bit group in the first DCI may be associated with one or more physical resource blocks in a narrowband. An association relationship between the bit included in the bit group and the PRB in the narrowband may be obtained through pre-configuration, and details are not described herein again. The first bit may be used to indicate whether the uplink data is correctly received, or to indicate whether the UE sends new uplink data.

The base station may receive the uplink data sent by the UE, and determine, based on the position of the PRB of the PUSCH occupied by the uplink data in the narrowband (to be specific, a specific PRB) and the association relationship between the bit in the bit group in the first DCI and the PRB in the narrowband, a bit that is in the bit group in the first DCI and associated with the PRB occupied by the uplink data. Then the associated bit in the first bit group is obtained as the first bit based on the determined first bit group. Optionally, the position of the PRB in the narrowband may be determined by using the PRB index in the narrowband.

X may be used to indicate the quantity of bit groups included in the first DCI, and may further be used to indicate a quantity of narrowbands associated with all the bit groups in the first DCI. Optionally, the indication information of X may be used to indicate a value of X, and a maximum value of X may be a value fixed in a protocol. For example, the maximum value of X may be 1, 2, 3 or 4. For example, if the maximum value of X is 1, the second DCI may not need to include the indication information of X. For another example, if the maximum value of X is 4, the value of X may be any one of 1 to 4, and the second DCI may include the indication information of X. For example, if the second DCI indicates that the value of X is 2, it may indicate that the first DCI has 2 bit groups. Further, the information about the first bit group may be used to indicate the first bit group in all the bit groups constituted by the bits of the first DCI; and the narrowband offset information may indicate a narrowband offset between a narrowband associated with the first bit group and a narrowband associated with a bit group constituted by low (or high) 6 bits of the first DCI. For example, if the narrowband associated with the first bit group is a narrowband 0, the narrowband associated with the bit group constituted by the low (or high) 6 bits of the first DCI is a narrowband 3, the narrowband offset information is 3, which may indicate an offset by 3 narrowbands.

Further, the base station may also determine the first bit group in all the bit groups constituted by the bits of the first DCI, to be specific, determine a position of the first bit group in which the first bit is located, to determine a position of the first bit in all the bits of the first DCI. Optionally, an order of determining, by the base station, the bit associated with the PRB occupied by the uplink data and determining, by the base station, the first bit group is not limited. For example, the bit associated with the PRB occupied by the uplink data may be determined first, and then the first bit group in which the bit associated with the PRB occupied by the uplink data is located is determined; or the first bit group may be determined first, and then the bit that is associated with the PRB occupied by the uplink data and that is in the first bit group are determined; or the first bit group and the bit associated with the PRB occupied by the uplink data may be determined simultaneously. This is not limited in this application.

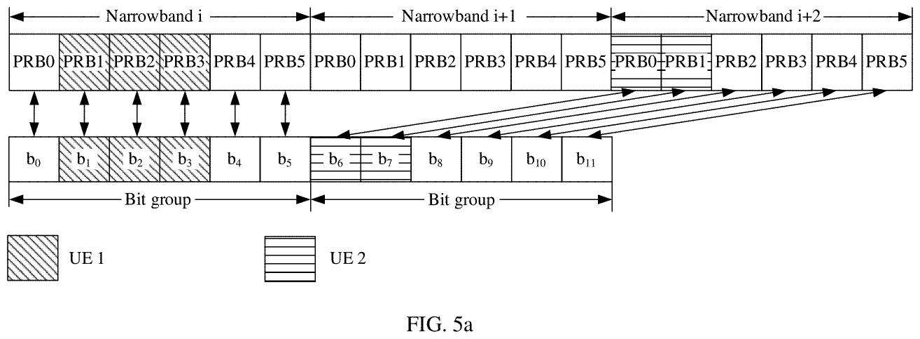

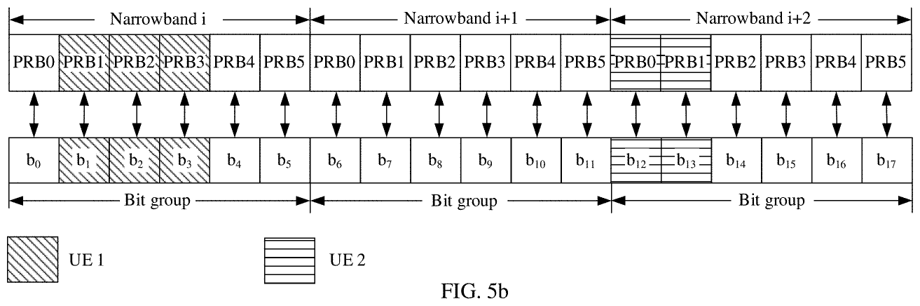

Optionally, the second DCI may further include the information about the first bit group and the indication information of the quantity X of the bit groups of the first DCI. Therefore, when determining the first bit group in the first DCI, the base station may determine the first bit group based on the information about the first bit group. In this manner, the information about the first bit group indicates the first bit group in all the bit groups, so that the base station may directly determine the first bit group. For example, the bits of the first DCI constitute 2 bit groups in total, and the 2 bit groups associate with 2 narrowbands, the information about the first bit group may be 1 bit, to indicate one of the 2 bit groups, and the indicated bit group is the first bit group. Further, in this manner, the narrowbands associated with all the bit groups in the first DCI may be continuous narrowbands or discontinuous narrowbands in terms of frequency. As shown in FIG. 5a, if the bit groups of the first DCI are associated with discontinuous narrowbands, it is assumed that all the bits of the first DCI constitute 2 bit groups, and the 2 bit groups are associated with discontinuous narrowbands and used to schedule uplink data of UE 1 and UE 2 separately. In addition, it is assumed that PUSCH resources occupied by the UE 1 are a PRB 1, a PRB 2, and a PRB 3 in a narrowband i, and PUSCH resources occupied by the UE 2 are a PRB 0 and a PRB 1 in a narrowband i+2, information about a first bit group in the second DCI that is used to allocate the PUSCH resources for the UE 1 is 0, indicating that a bit group constituted by bits b₀ to b₅ is the first bit group of the UE 1, and information about a first bit group in the second DCI that is used to allocate the PUSCH resources for the UE 2 is 1, indicating that a bit group constituted by bits b₆ to b₁₁ is the first bit group of the UE 2. The first DCI indicates, to the UE 1 and the UE 2, whether the uplink data is correctly received, or whether new uplink data is sent. b₁, b₂, and b₃ are the first bit of the UE 1, and b₆ and b₇ are the first bit of the UE 2. In this way, the base station can determine the first bit group based on the information about the first bit group. If the bit groups of the first DCI are associated with continuous narrowbands, a manner of determining the first bit group based on the information about the first bit group is similar to the manner of determining the first bit group when the bit groups of the first DCI are associated with discontinuous narrowbands, and details are not described herein again.

Optionally, the second DCI may further include the narrowband offset information and the indication information of the quantity X of the bit groups of the first DCI. Therefore, when determining the first bit group in the first DCI, the base station may determine the first bit group based on the narrowband offset information. For example, it is assumed that the bits of the first DCI constitute three bit groups in total, and the three bit groups are associated with three narrowbands, and the narrowband offset information may be 2 bit, to indicate that which one of 0, 1, and 2 is a narrowband offset between a narrowband associated with the first bit group and a narrowband associated with a bit group constituted by low (or high) 6 bits of the first DCI. In this manner, the narrowbands associated with all the bit groups of the first DCI may be continuous narrowbands in terms of frequency. As shown in FIG. 5b, it is assumed that all the bits in the first DCI constitute 3 bit groups, and the 3 bit groups are associated with continuous narrowbands to schedule uplink data of UE 1 and UE 2. In addition, it is assumed that PUSCH resources occupied by the UE 1 are a PRB 1, a PRB 2, and a PRB 3 in a narrowband i, and PUSCH resources occupied by the UE 2 are a PRB 0 and a PRB 1 in a narrowband i+2. Assuming that the narrowband offset information indicates a narrowband offset between a narrowband associated with the first bit group and a narrowband associated with a bit group constituted by low 6 bits of the first DCI, narrowband offset information in the second DCI that is used to allocate PUSCH resources to the UE 1 is 0, indicating that a bit group constituted by bits b₀ to b₅ is the first bit group of the UE 1, and narrowband offset information in the second DCI that is used to allocate PUSCH resources to the UE 2 is 2, indicating that a bit group constituted by bits b₁₂ to b₁₇ is the first bit group of the UE 2. The first DCI indicates, to the UE 1 and the UE 2, whether the uplink data is correctly received, or whether new uplink data is sent. b₁, b₂, and b₃ are the first bit of the UE 1, and b₁₂ and b₁₃ are the first bit of the UE 2. In this way, the base station can determine the first bit group based on the narrowband offset information.

204. The base station sends the first DCI.

205: The UE determines the first bit group in the first DCI and the first bit in the first bit group based on the second DCI.

206: The UE determines, based on the first bit, whether the uplink data is correctly received or whether new uplink data is sent.

After determining the first bit group and the first bit, the base station may send the first DCI. Optionally, before sending the first DCI, the base station may further scramble CRC of the first DCI. For example, the base station may determine, based on an index of a narrowband in which the PRB carrying the uplink data is located and the narrowband offset information, a scrambling code used for scrambling, and send the scrambled first DCI to the UE after scrambling the CRC of the first DCI by using the scrambling code.

Optionally, when the quantity of bit groups constituted by the bits of the first DCI is one, to be specific, when X is 1, the base station may determine a scrambling code of CRC of the first DCI based on an index of a narrowband in which the PRB of the PUSCH carrying the uplink data is located. In this scenario, the second DCI may not include the indication information of X, the information about the first bit group, and the narrowband offset information. It is assumed that valid payload bits (information bits, namely, the bits of the first DCI) of the first DCI are a₀, a₂, a₃, . . . a_{A-1}, and check bits (namely, bits of the CRC) of the first DCI are p₀, p₁, p₂, p₃, . . . , p_{L-1}, where A is a size of valid payload, and L is a quantity of the check bits, for example, L=16. Further, the valid payload bits and the check bits of the first DCI may be connected, to obtain b₀, b₁, b₂, b₃, . . . , b_{B-1}, where B=A+L. Further, the check bits of the CRC of the first DCI in the bits b₀, b₁, b₂, b₃, . . . , b_{B-1} may be scrambled, to obtain bits c₀, c₁, c₂, c₃, . . . , c_{B-1}. A relationship between bits cₖ and bₖ may be as follows:

cₖ=bₖ, when k=0,1,2, . . . ,or A−1

cₖ=(bₖ+x_{NB,k-A})mod 2, when k=A,A+1,A+2, . . . ,or A+15

x_{NB,0}, x_{NB,1}, . . . , x_{NB,15} is the scrambling code determined based on the index of the narrowband in which the PRB of the PUSCH carrying the uplink data. For example, x_{NB,0}, x_{NB,1}, . . . , x_{NB,15} may be 16 binary digits indicating the narrowband index. For example, when the index of the narrowband in which the PRB of the PUSCH is located is 15, a value of x_{NB,0}, x_{NB,1}, . . . , x_{NB,15} is 0000 0000 0000 1111.

Optionally, when the quantity of bit groups constituted by the bits of the first DCI is greater than or equal to 1, to be specific, when X is greater than or equal to 1, the base station may determine a scrambling code of CRC of the first DCI based on an index of a narrowband in which the PRB of the PUSCH carrying the uplink data is located and the narrowband offset information. In this scenario, the second DCI needs to include the indication information of X and the narrowband offset information. Further, optionally, the second DCI may further include information of the first bit. A relationship between bits cₖ and bₖ may be as follows:

cₖ=bₖ, when k=0,1,2, . . . ,or A−1

cₖ=(bₖ+x_{NB,k-A}−x_{NBOffset,k-A})mod 2, when k=A,A+1,A+2, . . . ,or A+15

x_{NB,k-A}−x_{NBOffset,k-A} is the scrambling code of the CRC of the first DCI, x_{NB,0}, x_{NB,1}, . . . , x_{NB,15} is determined based on the index of the narrowband in which the PRB of the PUSCH carrying the uplink data is located. For example, x_{NB,0}, x_{NB,1}, . . . , x_{NB,15} may be 16 binary digits indicating the narrowband index, and details are not described herein again. x_{NBOffset,0}, x_{NBOffset,1}, . . . , x_{NBOffset,15} may be determined based on the narrowband offset information. For example, x_{NBOffset,0}, x_{NBOffset,1}, . . . , x_{NBOffset,15} may be 16 binary digits indicating a narrowband offset indicated by the narrowband offset information. For example, when the narrowband offset indicated by the narrowband offset information is 3, a value of x_{NBOffset,0}, x_{NBOffset,1}, . . . , x_{NBOffset,15} is 0000 0000 0000 0011.

Further, the UE may receive the first DCI sent by the base station, and determine the first bit group and the first bit. A manner of determining, by the UE, the first bit group and the first bit may be the same as the foregoing manner of determining, by the base station, the first bit group and the first bit, and details are not described herein again. Optionally, when receiving the first DCI sent by the base station, the UE may descramble, by using a scrambling code determined in a preset manner, the CRC of the DCI sent by the base station, to obtain the first DCI. The manner of determining, by the UE, the scrambling code for descrambling may be the same as the foregoing manner of determining, by the base station, the scrambling code for scrambling, and details are not described herein again.

Further, after determining the first bit, the UE may determine, based on feedback information indicated by the first bit, whether the uplink data is correctly received, or whether new uplink data is sent. The first bit may indicate an ACK or NACK by using 0 or 1 or by using an NDI. For details, refer to the foregoing related descriptions, and details are not described herein again.

In this embodiment of the present disclosure, the UE may send the uplink data to the base station. The base station may determine the first bit group in the first DCI and the first bit in the first bit group after receiving the uplink data, and the first bit is used to indicate whether the uplink data is correctly received, or whether the new uplink data is sent. After receiving the first DCI, the UE may determine, as indicated by the first bit, whether to retransmit the data, so that feedback information of a plurality of pieces of uplink data can be carried by using one piece of DCI. Therefore, feedback resource overheads are reduced, and feedback efficiency is increased, helping resolve a problem of high overheads of feedback resources for feeding back whether the uplink data is correctly received and low feedback efficiency. In addition, when a quantity N of PRBs of the PUSCH is greater than 1, feedback reliability can be improved by setting N bits used for feedback to a same value.

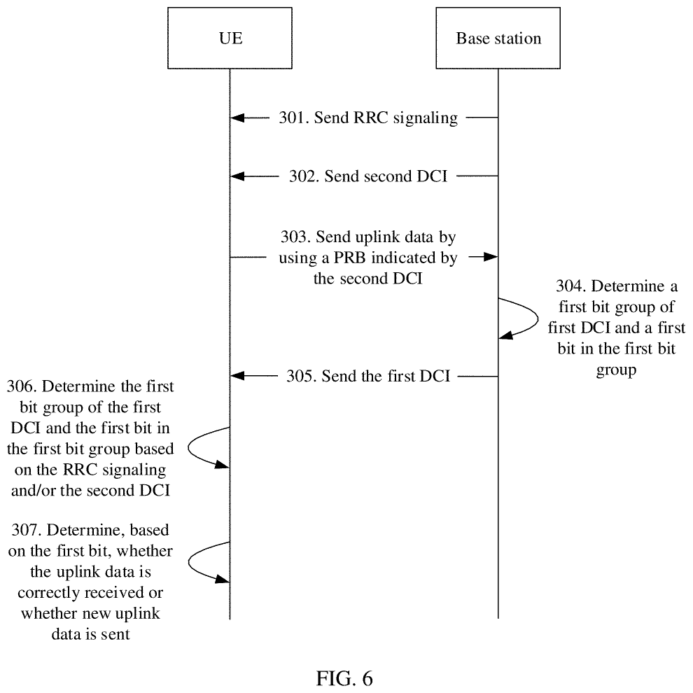

FIG. 6 is a schematic interactive diagram of another feedback method for uplink data according to an embodiment of the present disclosure. As shown in FIG. 6, the uplink data feedback method according to this embodiment of the present disclosure may include the following operations.

301. A base station sends RRC signaling, and the RRC signaling includes indication information of a quantity X of bit groups of first DCI.

A difference between this embodiment of the present disclosure and the foregoing embodiment shown in FIG. 4 is that the base station may notify UE of the indication information of X by using the RRC signaling. Optionally, the RRC signaling may be dedicated signaling.

302. The base station sends second DCI, and the second DCI includes at least one of information about a PRB carrying uplink data of the UE, information about a first bit group, or narrowband offset information.

303: The UE sends the uplink data to the base station by using the PRB indicated by the second DCI.

The second DCI may be used to schedule the uplink data. For example, the second DCI may include resource allocation, such as PRB information and a modulation and coding scheme, of a PUSCH carrying the uplink data. The PRB information may be used to indicate a specific position of the PRB carrying the uplink data. In this way, the UE may determine, based on the second DCI, the PRB of the PUSCH carrying the uplink data, and transmit the uplink data by using the PRB.

304: The base station determines the first bit group in first DCI and a first bit in the first bit group.

Bits of the first DCI constitute at least one bit group, and one or more bits included in each bit group in the first DCI may be associated with one or more physical resource blocks in a narrowband. An association relationship between the bit included in the bit group and the PRB in the narrowband may be obtained through pre-configuration, and details are not described herein again. The first bit may be used to indicate whether the uplink data is correctly received, or to indicate whether the UE sends new uplink data.

Optionally, when a value of X indicated by the indication information of X included in the RRC signaling is greater than 1, it may indicate that the quantity of the bit groups included in the first DCI is greater than 1, and the quantity of the bit groups is the same as the value of X. When determining the first bit group, the base station may determine the first bit group based on the information about the first bit group included in the second DCI, or determine the first bit group based on the narrowband offset information included in the second DCI. When determining the first bit, the base station may determine the first bit based on the position of the PRB occupied by the uplink data in a narrowband and an association relationship between the bit in the first bit group and the PRB in the narrowband. For details of the manner of determining the first bit group and the first bit, refer to the related descriptions of the manner of determining the first bit group and the first bit in the foregoing embodiment shown in FIG. 4, and details are not described herein again.

Optionally, when a value of X indicated by the indication information of X included in the RRC signaling is equal to 1, to be specific, when the quantity of the bit groups included in the first DCI is 1, the bits included in the first DCI constitute the first bit group. In this scenario, the second DCI may include the information about the first bit group and/or the narrowband offset information, to determine the first bit group based on the information about the first bit group and/or the narrowband offset information. For details, refer to the related descriptions of the manner of determining the first bit group in the foregoing embodiment shown in FIG. 4, and details are not described herein again. Alternatively, the second DCI may not include the information about the first bit group and the narrowband offset information. Further, for details of the manner of determining the first bit group, refer to the related descriptions of the manner of determining the first bit group in the foregoing embodiment shown in FIG. 4, and details are not described herein again.

305. The base station sends the first DCI.

306: The UE determines the first bit group in the first DCI and the first bit in the first bit group based on the RRC signaling and/or the second DCI.

307: The UE determines, based on the first bit, whether the uplink data is correctly received or whether new uplink data is sent.

After determining the first bit group and the first bit, the base station may send the first DCI. Optionally, before sending the first DCI, the base station may further scramble CRC of the first DCI. For example, the base station may determine, based on an index of a narrowband in which the PRB carrying the uplink data is located and the narrowband offset information, a scrambling code used for scrambling, and send the scrambled first DCI to the UE after scrambling the CRC of the first DCI by using the scrambling code.

Optionally, when the value of X indicated by the indication information of X included in the RRC signaling is equal to 1, to be specific, when the quantity of the bit groups included in the first DCI is 1, the base station may determine the scrambling code of the CRC of the first DCI based on the index of the narrowband in which the PRB of the PUSCH carrying the uplink data is located. In this scenario, the second DCI may not include the information about the first bit group and the narrowband offset information. For details of a manner of determining the scrambling code, refer to the related descriptions of the manner of determining the scrambling code in the foregoing embodiment shown in FIG. 4, and details are not described herein again. Further, optionally, in this scenario, the second DCI may alternatively include the narrowband offset information. In this case, a value of a narrowband offset indicated by the narrowband offset information may be 0. For example, a value of x_{NBOffset,0}, x_{NBOffset,1}, . . . , x_{NBOffset,15} is 0000 0000 0000 0000.

Optionally, when the value of X indicated by the indication information of X included in the RRC signaling is greater than 1, to be specific, when the quantity of the bit groups included in the first DCI is greater than 1, the base station may determine the scrambling code of the CRC of the first DCI according to the index of the narrowband in which the PRB of the PUSCH carrying the uplink data is located and the narrowband offset information. In this scenario, the second DCI needs to include the narrowband offset information. Further, optionally, the second DCI may further include the information about the first bit group. For details of a manner of determining the scrambling code, refer to the related descriptions of the manner of determining the scrambling code in the foregoing embodiment shown in FIG. 4, and details are not described herein again.

Further, the UE may receive the first DCI sent by the base station, and determine the first bit group and the first bit. A manner of determining, by the UE, the first bit group and the first bit may be the same as the foregoing manner of determining, by the base station, the first bit group and the first bit, and details are not described herein again. Optionally, when receiving the first DCI sent by the base station, the UE may descramble, by using a scrambling code determined in a preset manner, the CRC of the DCI sent by the base station, to obtain the first DCI. The manner of determining, by the UE, the scrambling code for descrambling may be the same as the foregoing manner of determining, by the base station, the scrambling code for scrambling, and details are not described herein again.

Further, after determining the first bit, the UE may determine, based on feedback information indicated by the first bit, whether the uplink data is correctly received, or whether new uplink data is sent. The first bit may indicate an ACK or NACK by using 0 or 1 or by using an NDI. For details, refer to the foregoing related descriptions, and details are not described herein again.

In this embodiment of the present disclosure, the UE may send the uplink data to the base station. The base station may determine the first bit group in the first DCI and the first bit in the first bit group after receiving the uplink data, and the first bit is used to indicate whether the uplink data is correctly received, or whether the new uplink data is sent. After receiving the first DCI, the UE may determine, as indicated by the first bit, whether to retransmit the data, so that feedback information of a plurality of pieces of uplink data can be carried by using one piece of DCI. Therefore, feedback resource overheads are reduced, and feedback efficiency is increased, helping resolve a problem of high overheads of feedback resources for feeding back whether the uplink data is correctly received and low feedback efficiency. In addition, when a quantity N of PRBs of the PUSCH is greater than 1, feedback reliability can be improved by setting N bits used for feedback to a same value.

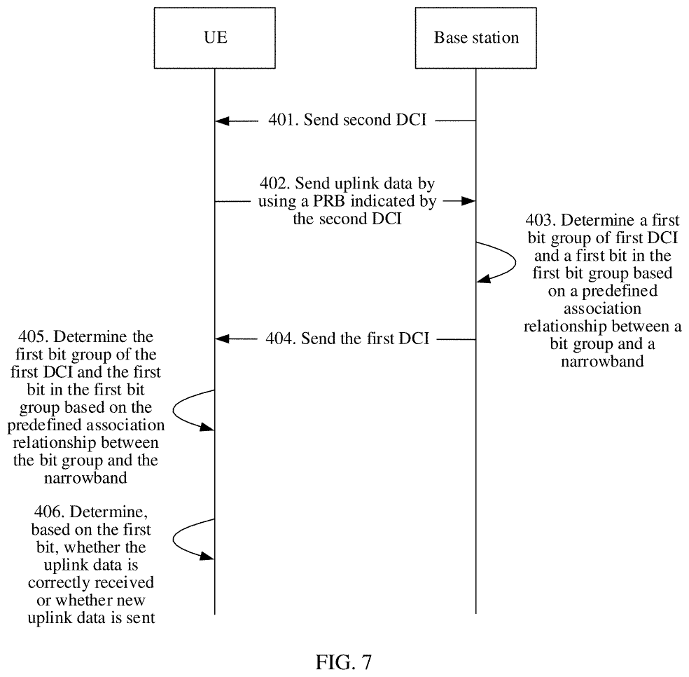

FIG. 7 is a schematic interactive diagram of still another feedback method for uplink data according to an embodiment of the present disclosure. As shown in FIG. 7, the uplink data feedback method according to this embodiment of the present disclosure may include the following operations.

401. A base station sends second DCI, and the second DCI includes information about a PRB used to carry uplink data of UE.

402: The UE sends the uplink data to the base station by using the PRB indicated by the second DCI.

The second DCI may be used to schedule the uplink data. For example, the second DCI may include resource allocation, such as PRB information and a modulation and coding scheme, of a PUSCH carrying the uplink data. The PRB information may be used to indicate a specific position of the PRB carrying the uplink data. In this way, the UE may determine, based on the second DCI, the PRB of the PUSCH carrying the uplink data, and transmit the uplink data by using the PRB.

403. The base station determines a first bit group in first DCI and a first bit in the first bit group based on a predefined association relationship between a bit group and a narrowband.

Optionally, the association relationship between the bit group and the narrowband may be obtained through pre-configuration. For example, a quantity of bit groups in the first DCI and an association relationship between each bit group and a narrowband index may be agreed on by using a protocol, so that a bit group associated with a narrowband in which the PRB of the PUSCH carrying the uplink data is located is the first bit group.

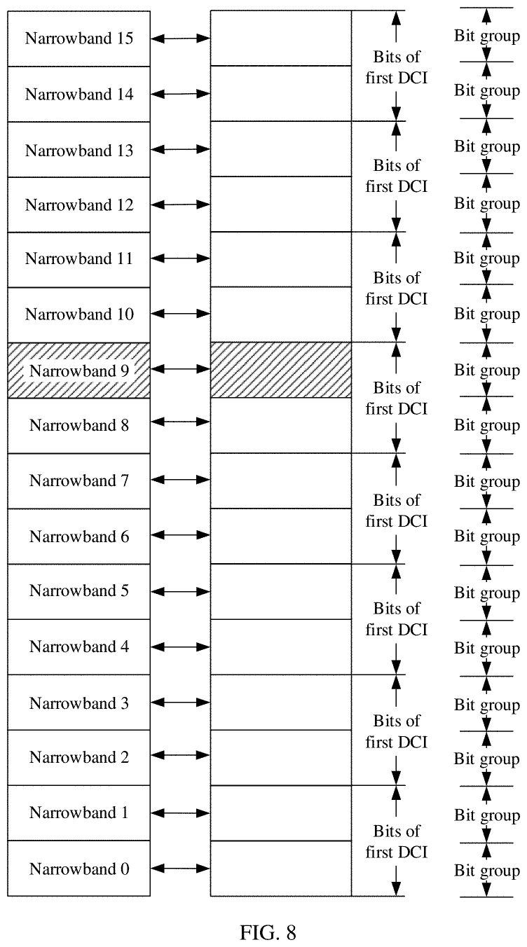

For example, it is assumed that it is predefined that bits of the first DCI constitute 2 bit groups, and the 2 bit groups are associated with 2 continuous narrowbands. For example, low (high) 6 bits of the first DCI constitute a first bit group, and high (low) 6 bits constitute a second bit group. Optionally, a narrowband associated with each bit group in the first DCI may be determined in the following manner: a narrowband index associated with the first bit group in the first DCI is an even number, or a narrowband associated with the first bit group is a narrowband having an even index; a narrowband index associated with the second bit group is an odd number, or a narrowband associated with the second bit group is a narrowband having an odd index. If a narrowband in which the PRB of the PUSCH carrying the uplink data is located is a narrowband having an even index, a bit group constituted by low (high) 6 bits of the first DCI is the first bit group. If a narrowband in which the PRB of the PUSCH carrying the uplink data is located is a narrowband having an odd index, a bit group constituted by high (low) 6 bits of the first DCI is the first bit group. As shown in FIG. 8, if the narrowband in which the PRB of the PUSCH carrying the uplink data is located is a narrowband having an index of 9, a bit group shown by a shaded part may be used as the first bit group.

For another example, it is assumed that it is predefined that bits of the first DCI constitute 1 bit group, and a narrowband associated with the bit group in the first DCI may be determined in the following manner: 1 bit group in the first DCI is associated with 1 narrowband, so that it may be determined that the 1 bit group constituted by the bits of the first DCI is the first bit group. Similarly, it may alternatively be predefined that bits of the first DCI constitute 3 or 4 or more bit groups, and the bit groups are associated with a corresponding quantity of continuous narrowbands, and details are not described in detail herein.

404. The base station sends the first DCI.

405. The UE determines the first bit group of the first DCI and the first bit in the first bit group based on the predefined association relationship between the bit group and the narrowband.

406: The UE determines, based on the first bit, whether the uplink data is correctly received or whether new uplink data is sent.

After determining the first bit group and the first bit, the base station may send the first DCI. Optionally, before sending the first DCI, the base station may further scramble CRC of the first DCI. For example, the base station may determine, based on an index of the narrowband in which the PRB carrying the uplink data is located, a scrambling code used for scrambling, and send the scrambled first DCI to the UE after scrambling the CRC of the first DCI with the scrambling code.

For example, in this embodiment of the present disclosure, a relationship between bits cₖ and bₖ (for descriptions of cₖ and bₖ, refer to descriptions of the embodiment shown in FIG. 4) may be:

cₖ=bₖ, when k=0,1,2, . . . ,A−1

cₖ=(bₖ+x_{NB,k-A})mod 2, when k=A,A+1,A+2, . . . ,A+15

x_{NB,0}, x_{NB,1}, . . . , x_{NB,15} is the scrambling code determined based on the index of the narrowband in which the PRB of the PUSCH carrying the uplink data. For example, x_{NB,0}, x_{NB,1}, . . . , x_{NB,15} may be 16 binary digits indicating a value of fun (the narrowband index). The fun (the narrowband index) indicates a function of the narrowband index.

For example, it is predefined that the bits of the first DCI constitute 2 bit groups, and the 2 bit groups are associated with 2 continuous narrowbands. In this case, the fun may be:

$$\begin{matrix}fun ( the \\ narrowband index )\end{matrix} = \{ \begin{matrix}the narrowband & when ( the narrowband \\ index & index ) mod 2 = 0 \\ the narrowband & when ( the narrowband \\ index - 1 & index ) mod 2 = 1\end{matrix} .$$

In this scenario, assuming that the index of the narrowband in which the PRB of the PUSCH carrying the uplink data is located is 9, a value of x_{NB,0}, x_{NB,1}, . . . , x_{NB,15} is 0000 0000 0000 1000.

For another example, it is predefined that the bits of the first DCI constitute 1 bit group, and the bit group is associated with 1 narrowband. In this case, fun (the narrowband index)=the narrowband index.

Further, the UE may receive the first DCI sent by the base station, and determine the first bit group and the first bit based on the predefined association relationship between the bit group and the narrowband. A manner of determining, by the UE, the first bit group and the first bit may be the same as a manner of determining, by the base station, the first bit group and the first bit, and details are not described herein again. Optionally, when receiving the first DCI sent by the base station, the UE may descramble, by using a scrambling code determined in a preset manner, the CRC of the DCI sent by the base station, to obtain the first DCI. The manner of determining, by the UE, the scrambling code for descrambling may be the same as a manner of determining the scrambling code by the base station for scrambling, and details are not described herein again.

Further, after determining the first bit, the UE may determine, based on feedback information indicated by the first bit, whether the uplink data is correctly received, or whether new uplink data is sent. The first bit may indicate an ACK or NACK by using 0 or 1 or by using an NDI. For details, refer to the foregoing related descriptions, and details are not described herein again.

In this embodiment of the present disclosure, the UE may send the uplink data to the base station. The base station may determine the first bit group in the first DCI and the first bit in the first bit group after receiving the uplink data, and the first bit is used to indicate whether the uplink data is correctly received, or whether the new uplink data is sent. After receiving the first DCI, the UE may determine, as indicated by the first bit, whether to retransmit the data, so that feedback information of a plurality of pieces of uplink data can be carried by using one piece of DCI. Therefore, feedback resource overheads are reduced, and feedback efficiency is increased, helping resolve a problem of high overheads of feedback resources for feeding back whether the uplink data is correctly received and low feedback efficiency. In addition, when a quantity N of PRBs of the PUSCH is greater than 1, feedback reliability can be improved by setting N bits used for feedback to a same value.

FIG. 9 is a schematic structural diagram of a network device according to an embodiment of the present disclosure. As shown in FIG. 9, the network device in this embodiment of the present disclosure may include a transceiver unit 11 and a processing unit 12.

The transceiver unit 11 is configured to receive uplink data from a terminal device.

The processing unit 12 is configured to determine a first bit group of first downlink control information and a first bit in the first bit group, where bits of the first downlink control information include X bit groups, X is a positive integer, the X bit groups include the first bit group, one or more bits included in each of the X bit groups are associated with one or more physical resource blocks in a narrowband in a system bandwidth, and the first bit is used to indicate whether the uplink data is correctly received, or to indicate whether new uplink data is sent by the terminal device.

The transceiver unit 11 is further configured to send the first downlink control information.

Optionally, when determining the first bit in the first bit group, the processing unit 12 may be configured to:

determine a physical resource block that is occupied by the uplink data and in a narrowband; and

determine, in one or more bits included in the first bit group of the first downlink control information, the first bit associated with the physical resource block.

Optionally, when determining the first bit group of the first downlink control information, the processing unit 12 is configured to:

determine, based on a predefined association relationship between a bit group and a narrowband, a bit group associated with a narrowband in which a physical resource block occupied by the uplink data is located, and use the associated bit group as the first bit group.

Optionally, the processing unit 12 is further configured to: determine a scrambling code of CRC of the first downlink control information based on an index of the narrowband in which the physical resource block occupied by the uplink data is located, and scramble the CRC of the first downlink control information by using the scrambling code.

Further, when sending the first downlink control information, the transceiver unit 11 may be configured to:

send the scrambled first downlink control information.

Optionally, the transceiver unit 11 is further configured to send second downlink control information used to schedule the uplink data, where the second downlink control information includes at least one of indication information of the quantity X of the bit groups of the first downlink control information, information about the first bit group, or narrowband offset information.

Further, when determining the first bit group of the first downlink control information, the processing unit 12 may be configured to:

determine the first bit group of the first downlink control information based on the second downlink control information.

Optionally, the transceiver unit 11 may further be configured to send RRC signaling.

The transceiver unit 11 is further configured to send second downlink control information used to schedule the uplink data.

The RRC signaling may include indication information of the quantity X of the bit groups of the first downlink control information; and the second downlink control information may include at least one of information about the first bit group and narrowband offset information.

Further, when determining the first bit group of the first downlink control information, the processing unit 12 may be configured to:

determine the first bit group of the first downlink control information based on the RRC signaling and/or the second downlink control information.

Optionally, the processing unit 12 is further configured to: determine a scrambling code of CRC of the first downlink control information based on an index of the narrowband in which the physical resource block occupied by the uplink data is located and the narrowband offset information, and scramble the CRC of the first downlink control information by using the scrambling code.

Further, when sending the first downlink control information, the transceiver unit 11 may be configured to:

send the scrambled first downlink control information.

Optionally, a quantity of bits included in the first bit is the same as a quantity of physical resource blocks occupied by the uplink data, and when the quantity of physical resource blocks occupied by the uplink data is greater than 1, the bits included in the first bit have a same value.

Optionally, the network device may implement, by using the foregoing units, some or all of the operations performed by the network device, such as a base station, in the uplink data feedback method in the embodiments illustrated in FIG. 3 to FIG. 8. It should be understood that this embodiment of the present disclosure is an apparatus embodiment corresponding to the method embodiment, and descriptions of the method embodiment are also applicable to this embodiment of the present disclosure.

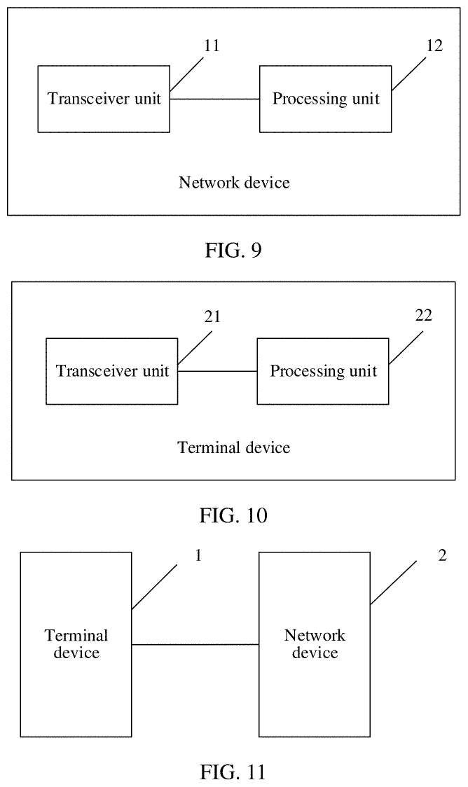

FIG. 10 is a schematic structural diagram of a terminal device according to an embodiment of the present disclosure. As shown in FIG. 10, the terminal device in this embodiment of the present disclosure may include a transceiver unit 21 and a processing unit 22.

The transceiver unit 21 is configured to send uplink data.

The transceiver unit 21 is further configured to receive first downlink control information from a network device.

The processing unit 22 is configured to determine a first bit group of the first downlink control information and a first bit in the first bit group, where bits of the first downlink control information include X bit groups, X is a positive integer, the X bit groups include the first bit group, and one or more bits included in each of the X bit groups are associated with one or more physical resource blocks in a narrowband in a system bandwidth.

The processing unit 22 may further be configured to determine, based on the first bit, whether the uplink data is correctly received, or whether new uplink data is sent.

Optionally, when determining the first bit in the first bit group, the processing unit 22 may be configured to:

determine a physical resource block that is occupied by the uplink data and in a narrowband; and

determine, in one or more bits included in the first bit group of the first downlink control information, the first bit associated with the physical resource block.

Optionally, when determining the first bit group of the first downlink control information, the processing unit 22 may be configured to:

determine, based on a predefined association relationship between a bit group and a narrowband, a bit group associated with a narrowband in which a physical resource block occupied by the uplink data is located, and use the associated bit group as the first bit group.

Optionally, the processing unit 22 may further be configured to determine a scrambling code of CRC of the first downlink control information based on an index of the narrowband in which the physical resource block occupied by the uplink data is located.

Further, when receiving the first downlink control information from the network device, the transceiver unit 21 may be configured to: descramble the CRC of the first downlink control information by using the scrambling code, to obtain the first downlink control information.

Optionally, the transceiver unit 21 may further be configured to receive second downlink control information from the network device, where the second downlink control information is used to schedule the uplink data, and the second downlink control information includes at least one of indication information of the quantity X of the bit groups of the first downlink control information, information about the first bit group, or narrowband offset information. Further, when determining the first bit group of the first downlink control information, the processing unit 22 may be configured to: determine the first bit group of the first downlink control information based on the second downlink control information.

Optionally, the transceiver unit 21 may further be configured to receive RRC signaling from the network device.

The transceiver unit 21 may further be configured to receive second downlink control information from the network device, where the RRC signaling includes indication information of the quantity X of the bit groups of the first downlink control information, the second downlink control information is used to schedule the uplink data, and the second downlink control information includes at least one of information about the first bit group and narrowband offset information.

Further, when determining the first bit group of the first downlink control information, the processing unit 22 may be configured to:

determine the first bit group of the first downlink control information based on the RRC signaling and/or the second downlink control information.

Optionally, the processing unit 22 may further be configured to determine a scrambling code of CRC of the first downlink control information based on an index of the narrowband in which the physical resource block occupied by the uplink data is located and the narrowband offset information.

Further, when receiving the first downlink control information from the network device, the transceiver unit 21 may be configured to:

descramble the CRC of the first downlink control information by using the scrambling code, to obtain the first downlink control information.

Optionally, a quantity of bits included in the first bit is the same as a quantity of physical resource blocks occupied by the uplink data, and when the quantity of physical resource blocks occupied by the uplink data is greater than 1, the bits included in the first bit have a same value.

Optionally, the terminal device may implement, by using the foregoing units, some or all of the operations performed by the terminal device, such as UE, in the uplink data feedback method in the embodiments illustrated in FIG. 3 to FIG. 8. It should be understood that this embodiment of the present disclosure is an apparatus embodiment corresponding to the method embodiment, and descriptions of the method embodiment are also applicable to this embodiment of the present disclosure.

In this embodiment of the present disclosure, the terminal device may send the uplink data to the network device. The network device may determine the first bit group in the first DCI and the first bit in the first bit group after receiving the uplink data, and the first bit is used to indicate whether the uplink data is correctly received, or whether the new uplink data is sent. After receiving the first DCI, the terminal device may determine, as indicated by the first bit, whether to retransmit the data, so that feedback information of a plurality of pieces of uplink data can be carried by using one piece of DCI, helping resolve a problem of high overheads of feedback resources for feeding back whether the uplink data is correctly received and low feedback efficiency.

FIG. 11 is a schematic structural diagram of an uplink data feedback system according to an embodiment of the present disclosure. As shown in FIG. 11, the system in this embodiment of the present disclosure may include: a terminal device 1 and a network device 2.

The terminal device 1 is configured to send uplink data.

The network device 2 is configured to: receive the uplink data; determine a first bit group of first downlink control information and a first bit in the first bit group; and send the first downlink control information. Bits of the first downlink control information constitute at least one bit group, and one or more bits included in each of the X bit groups are associated with one or more physical resource blocks in a narrowband in a system bandwidth. The first bit is used to indicate whether the uplink data is correctly received, or to indicate whether new uplink data is sent by the terminal device.

The terminal device 1 is further configured to: receive the first downlink control information; determine a first bit group of the first downlink control information and a first bit in the first bit group; and determine, based on the first bit, whether the uplink data is correctly received, or whether new uplink data is sent.

For the terminal device 1, refer to the related descriptions of the terminal device, such as UE, in the foregoing embodiments corresponding to FIG. 3 to FIG. 8, and for the network device 2, refer to the related descriptions of the network device, such as a base station, in the foregoing embodiments corresponding to FIG. 3 to FIG. 8. Details are not described herein again.

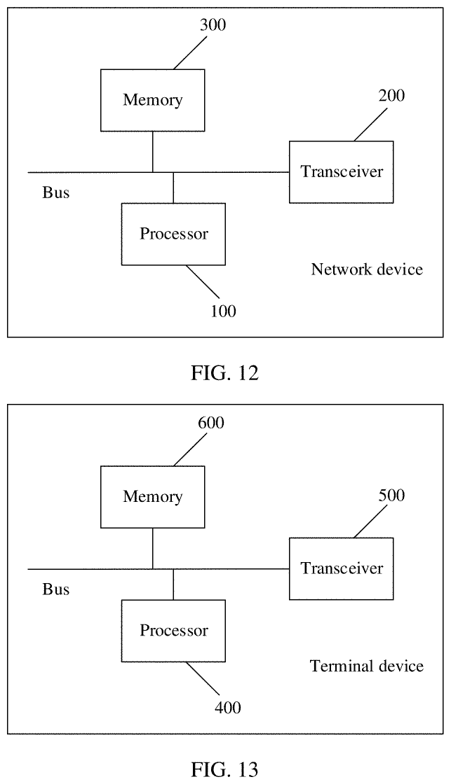

FIG. 12 is a schematic structural diagram of another network device according to an embodiment of the present disclosure. As shown in FIG. 12, the network device in this embodiment of the present disclosure may include: a transceiver 200 and a processor 100. The processor 100 is connected to the transceiver 200. Optionally, the network device may also include a memory 300, and the memory 300 may be connected to the processor 100.

The transceiver 200, the memory 300, and the processor 100 may be in data connection by using a bus or in another manner. In this embodiment, the connection by using the bus is used for description.

The processor 100 may be a central processing unit (CPU), a network processor (NP), or a combination of a CPU and an NP.

The processor 100 may further include a hardware chip. The hardware chip may be an application-specific integrated circuit (ASIC), a programmable logic device (PLD), or a combination thereof. The PLD may be a complex programmable logic device (CPLD), a field-programmable gate array (FPGA), a generic array logic (GAL), or any combination thereof.

The memory 300 may include a volatile memory such as a random-access memory (RAM); the memory may further include a non-volatile memory such as a flash memory, a hard disk drive (HDD) or a solid-state drive (SSD); and the memory 300 may further include a combination of memories of the foregoing types.

The network device may be a base station, or may be a terminal device.

Optionally, the memory 300 may be configured to store a program instruction, and the processor 100 may invoke the program instruction stored in the memory 300 to perform one or more operations in the embodiments shown in FIG. 3 to FIG. 8 or optional implementations of the embodiments, so that the network device implements the functions in the foregoing method. For example, the network device may implement, by using the foregoing components, some or all of the operations performed by the network device, such as a base station, in the uplink data feedback method in the embodiments illustrated in FIG. 3 to FIG. 8.

The processor 100 may be configured to: invoke the transceiver 200 to receive uplink data from a terminal device; determine a first bit group of first downlink control information and a first bit in the first bit group; and invoke the transceiver 200 to send the first downlink control information.

Bits of the first downlink control information include X bit groups, and X is a positive integer. The X bit groups include the first bit group, and one or more bits included in each of the X bit groups are associated with one or more physical resource blocks in a narrowband in a system bandwidth, and the first bit is used to indicate whether the uplink data is correctly received, or to indicate whether new uplink data is sent by the terminal device.

Optionally, when determining the first bit in the first bit group, the processor 100 may be configured to: determine a physical resource block that is occupied by the uplink data and in a narrowband, and determine, in one or more bits included in the first bit group of the first downlink control information, the first bit associated with the physical resource block.

Optionally, when determining the first bit group of the first downlink control information, the processor 100 may be configured to: determine, based on a predefined association relationship between a bit group and a narrowband, a bit group associated with a narrowband in which a physical resource block occupied by the uplink data is located, and use the associated bit group as the first bit group.

Optionally, the processor 100 may further be configured to determine a scrambling code of CRC of the first downlink control information based on an index of the narrowband in which the physical resource block occupied by the uplink data is located; and scramble the CRC of the first downlink control information by using the scrambling code. Further, when sending the first downlink control information, the processor 100 may be configured to: invoke the transceiver 200 to send the scrambled first downlink control information.

Optionally, the processor 100 is further configured to: invoke the transceiver 200 to send second downlink control information used to schedule the uplink data, where the second downlink control information includes at least one of indication information of a quantity of the bit groups of the first downlink control information, information about the first bit group, or narrowband offset information. Further, when determining the first bit group of the first downlink control information, the processor 100 may be configured to: determine the first bit group of the first downlink control information based on the second downlink control information.

Optionally, the processor 100 may further be configured to: invoke the transceiver 200 to send RRC signaling; and invoke the transceiver 200 to send second downlink control information used to schedule the uplink data, where the RRC signaling includes indication information of a quantity of the bit groups of the first downlink control information, and the second downlink control information includes at least one of information about the first bit group and narrowband offset information. Further, when determining the first bit group of the first downlink control information, the processor 100 may be configured to: determine the first bit group of the first downlink control information based on the RRC signaling and/or the second downlink control information.

Optionally, the processor 100 may further be configured to: determine a scrambling code of cyclic redundancy check CRC of the first downlink control information based on an index of the narrowband in which the physical resource block occupied by the uplink data is located and the narrowband offset information; and scramble the CRC of the first downlink control information by using the scrambling code. Further, when sending the first downlink control information, the processor 100 may be configured to: invoke the transceiver 200 to send the scrambled first downlink control information.

Optionally, a quantity of bits included in the first bit is the same as a quantity of physical resource blocks occupied by the uplink data, and when the quantity of physical resource blocks occupied by the uplink data is greater than 1, the bits included in the first bit have a same value.

FIG. 13 is a schematic structural diagram of another terminal device according to an embodiment of the present disclosure. As shown in FIG. 13, the terminal device in this embodiment of the present disclosure may include: a transceiver 500 and a processor 400. The processor 400 is connected to the transceiver 500. Optionally, the terminal device may further include a memory 600, and the memory 600 may be connected to the processor 400.

The transceiver 500, the memory 600, and the processor 400 may be in data connection by using a bus or in another manner. In this embodiment, the connection by using the bus is used for description.

The processor 400 may be a CPU, an NP, or a combination of a CPU and an NP.

The processor 400 may further include a hardware chip. The hardware chip may be an ASIC, a PLD, or a combination thereof. The PLD may be a CPLD, an FPGA, a GAL, or any combination thereof.

The memory 600 may include a volatile memory, such as a RAM; the memory may further include a non-volatile memory, such as a flash memory, an HDD, or an SSD; and the memory 600 may further include a combination of the foregoing types of memories.

Optionally, the memory 600 may be configured to store a program instruction, and the processor 400 may invoke the program instruction stored in the memory 600 to perform one or more operations in the embodiments shown in FIG. 3 to FIG. 8 or optional implementations of the embodiments, so that the terminal device implements the functions in the foregoing method. For example, the terminal device may implement, by using the foregoing components, some or all of the operations performed by the terminal device, such as UE, in the uplink data feedback method in the embodiments corresponding to FIG. 3 to FIG. 8.

The processor 400 may be configured to: invoke the transceiver 500 to send uplink data; invoke the transceiver 500 to receive first downlink control information from a network device; determine a first bit group of the first downlink control information and a first bit in the first bit group; and determine, based on the first bit, whether the uplink data is correctly received, or whether new uplink data is sent.

Bits of the first downlink control information include X bit groups, and X is a positive integer. The X bit groups include the first bit group, and one or more bits included in each of the X bit groups are associated with one or more physical resource blocks in a narrowband in a system bandwidth.

Optionally, when determining the first bit in the first bit group, the processor 400 may be configured to: determine a physical resource block that is occupied by the uplink data and in a narrowband, and determine, in one or more bits included in the first bit group of the first downlink control information, the first bit associated with the physical resource block.

Optionally, when determining the first bit group of the first downlink control information, the processor 400 may be configured to: determine, based on a predefined association relationship between a bit group and a narrowband, a bit group associated with a narrowband in which a physical resource block occupied by the uplink data is located, and use the associated bit group as the first bit group.

Optionally, the processor 400 may further be configured to determine a scrambling code of CRC of the first downlink control information based on an index of the narrowband in which the physical resource block occupied by the uplink data is located; and when receiving the first downlink control information from the network device, the processor 400 may be configured to descramble the CRC of the first downlink control information by using the scrambling code, to obtain the first downlink control information.

Optionally, the processor 400 may further be configured to invoke the transceiver 500 to receive second downlink control information from the network device, where the second downlink control information is used to schedule the uplink data, and the second downlink control information includes at least one of indication information of a quantity of the bit groups of the first downlink control information, information about the first bit group, or narrowband offset information. Further, when determining the first bit group of the first downlink control information, the processor 400 may be configured to: determine the first bit group of the first downlink control information based on the second downlink control information.

Optionally, the processor 400 may further be configured to: invoke the transceiver 500 to receive RRC signaling from the network device; and invoke the transceiver 500 to receive second downlink control information from the network device, where the RRC signaling may include indication information of a quantity of the bit groups of the first downlink control information, the second downlink control information is used to schedule the uplink data, and the second downlink control information may include at least one of information about the first bit group and narrowband offset information. Further, when determining the first bit group of the first downlink control information, the processor 400 may be configured to: determine the first bit group of the first downlink control information based on the RRC signaling and/or the second downlink control information.

Optionally, the processor 400 may further be configured to determine a scrambling code of CRC of the first downlink control information based on an index of the narrowband in which the physical resource block occupied by the uplink data is located and the narrowband offset information; and when receiving the first downlink control information from the network device, the processor 400 may be configured to descramble the CRC of the first downlink control information by using the scrambling code, to obtain the first downlink control information.

Optionally, a quantity of bits included in the first bit is the same as a quantity of physical resource blocks occupied by the uplink data, and when the quantity of physical resource blocks occupied by the uplink data is greater than 1, the bits included in the first bit have a same value.

In this embodiment of the present disclosure, the terminal device may send the uplink data to the network device. The network device may determine the first bit group in the first DCI and the first bit in the first bit group after receiving the uplink data, and the first bit is used to indicate whether the uplink data is correctly received, or whether the new uplink data is sent. After receiving the first DCI, the terminal device may determine, as indicated by the first bit, whether to retransmit the data, so that feedback information of a plurality of pieces of uplink data can be carried by using one piece of DCI, helping resolve a problem of high overheads of feedback resources for feeding back whether the uplink data is correctly received and low feedback efficiency.

In the foregoing embodiments, the descriptions of each embodiment have respective focuses. For a part that is not described in detail in an embodiment, refer to related descriptions in other embodiments.

All or some of the foregoing embodiments may be implemented by using software, hardware, firmware, or any combination thereof. When software is used to implement the embodiments, the embodiments may be implemented completely or partially in a form of a computer program product. The computer program product includes one or more computer instructions. When the computer program instructions are loaded and executed on a computer, the procedure or functions according to this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (SSD)), or the like.

1. A feedback method for uplink data, comprising:
receiving uplink data from a terminal device;
determining a first bit group of first downlink control information and a first bit in the first bit group, wherein bits of the first downlink control information comprise X bit groups, X is a positive integer, the X bit groups comprise the first bit group, one or more bits comprised in each of the X bit groups are associated with one or more physical resource blocks in a narrowband in a system bandwidth, and the first bit is used to indicate whether the uplink data is correctly received, or to indicate whether new uplink data is sent by the terminal device; and
sending the first downlink control information.

2. The method according to claim 1, wherein the determining the first bit in the first bit group comprises:
determining a physical resource block that is occupied by the uplink data and in the narrowband; and
determining, in one or more bits comprised in the first bit group of the first downlink control information, a first bit associated with the physical resource block.

3. The method according to claim 1, wherein the determining the first bit group of first downlink control information comprises:
determining, based on a predefined association relationship between a bit group and a narrowband, a bit group associated with a narrowband in which a physical resource block occupied by the uplink data is located, and using the associated bit group as the first bit group.

4. The method according to claim 1, further comprising:
determining a scrambling code of cyclic redundancy check (CRC) of the first downlink control information based on an index of the narrowband in which the physical resource block occupied by the uplink data is located; and
scrambling the CRC of the first downlink control information by using the scrambling code, wherein
the sending the first downlink control information comprises:
sending the scrambled first downlink control information.

5. The method according to claim 1, further comprising:
sending second downlink control information used to schedule the uplink data, wherein the second downlink control information comprises at least one of indication information of the quantity X of the bit groups of the first downlink control information, information about the first bit group, or narrowband offset information, wherein
the determining the first bit group of first downlink control information comprises:
determining the first bit group of the first downlink control information based on the second downlink control information.

6. The method according to claim 1, further comprising:
sending radio resource control (RRC) signaling;
sending second downlink control information used to schedule the uplink data, wherein
the RRC signaling comprises indication information of the quantity X of the bit groups of the first downlink control information; and the second downlink control information comprises at least one of information about the first bit group and narrowband offset information; and
the determining the first bit group of first downlink control information comprises:
determining the first bit group of the first downlink control information based on the RRC signaling and/or the second downlink control information.

7. The method according to claim 5, further comprising:
determining, based on an index of the narrowband in which a physical resource block occupied by the uplink data is located and the narrowband offset information, a scrambling code of cyclic redundancy check CRC of the first downlink control information; and
scrambling the CRC of the first downlink control information by using the scrambling code, wherein
the sending the first downlink control information comprises:
sending the scrambled first downlink control information.

8. The method according to claim 1, wherein a quantity of bits comprised in the first bit is the same as a quantity of physical resource blocks occupied by the uplink data, and when the quantity of physical resource blocks occupied by the uplink data is greater than 1, the bits comprised in the first bit have a same value.

9. A network device, comprising:
a transceiver unit, configured to receive uplink data from a terminal device; and
a processing unit, configured to determine a first bit group of first downlink control information and a first bit in the first bit group, wherein bits of the first downlink control information comprise X bit groups, X is a positive integer, the X bit groups comprise the first bit group, one or more bits comprised in each of the X bit groups are associated with one or more physical resource blocks in a narrowband in a system bandwidth, and the first bit is used to indicate whether the uplink data is correctly received, or to indicate whether new uplink data is sent by the terminal device, wherein
the transceiver unit is further configured to send the first downlink control information.

10. The network device according to claim 9, wherein when determining the first bit in the first bit group, the processing unit is configured to:
determine a physical resource block that is occupied by the uplink data and in a narrowband; and
determine, in one or more bits comprised in the first bit group of the first downlink control information, the first bit associated with the physical resource block.

11. The network device according to claim 9, wherein when determining the first bit group of the first downlink control information, the processing unit is configured to:
determine, based on a predefined association relationship between a bit group and a narrowband, a bit group associated with a narrowband in which a physical resource block occupied by the uplink data is located, and use the associated bit group as the first bit group.

12. The network device according to claim 9, wherein
the processing unit is further configured to: determine a scrambling code of cyclic redundancy check (CRC) of the first downlink control information based on an index of the narrowband in which the physical resource block occupied by the uplink data is located, and scramble the CRC of the first downlink control information by using the scrambling code; and
when sending the first downlink control information, the transceiver unit is configured to:
send the scrambled first downlink control information.

13. A terminal device, comprising:
a transceiver unit, configured to send uplink data, wherein
the transceiver unit is further configured to receive first downlink control information from a network device; and
a processing unit, configured to determine a first bit group of the first downlink control information and a first bit in the first bit group, wherein bits of the first downlink control information comprise X bit groups, X is a positive integer, the X bit groups comprise the first bit group, and one or more bits comprised in each of the X bit groups are associated with one or more physical resource blocks in a narrowband in a system bandwidth, wherein
the processing unit is further configured to determine, based on the first bit, whether the uplink data is correctly received, or whether new uplink data is sent.

14. The terminal device according to claim 13, wherein when determining the first bit in the first bit group, the processing unit is configured to:
determine a physical resource block that is occupied by the uplink data and in a narrowband; and
determine, in one or more bits comprised in the first bit group of the first downlink control information, the first bit associated with the physical resource block.

15. The terminal device according to claim 13, wherein when determining the first bit group of the first downlink control information, the processing unit is configured to:
determine, based on a predefined association relationship between a bit group and a narrowband, a bit group associated with a narrowband in which a physical resource block occupied by the uplink data is located, and use the associated bit group as the first bit group.

16. The terminal device according to claim 13, wherein
the processing unit is further configured to determine a scrambling code of cyclic redundancy check (CRC) of the first downlink control information based on an index of the narrowband in which the physical resource block occupied by the uplink data is located; and
when receiving the first downlink control information from the network device, the transceiver unit is configured to:
descramble the CRC of the first downlink control information by using the scrambling code, to obtain the first downlink control information.

17. The terminal device according to claim 13, wherein
the transceiver unit is further configured to receive second downlink control information from the network device, wherein the second downlink control information is used to schedule the uplink data, and the second downlink control information comprises at least one of indication information of the quantity X of the bit groups of the first downlink control information, information about the first bit group, or narrowband offset information; and
when determining the first bit group of the first downlink control information, the processing unit is configured to:
determine the first bit group of the first downlink control information based on the second downlink control information.

18. The terminal device according to claim 13, wherein
the transceiver unit is further configured to receive radio resource control (RRC) signaling from the network device;
the transceiver unit is further configured to receive second downlink control information from the network device, wherein the RRC signaling comprises indication information of the quantity X of the bit groups of the first downlink control information, the second downlink control information is used to schedule the uplink data, and the second downlink control information comprises at least one of information about the first bit group and narrowband offset information; and
when determining the first bit group of the first downlink control information, the processing unit is configured to:
determine the first bit group of the first downlink control information based on the RRC signaling and/or the second downlink control information.

19. The terminal device according to claim 17, wherein
the processing unit is further configured to determine a scrambling code of cyclic redundancy check (CRC) of the first downlink control information based on an index of a narrowband in which a physical resource block occupied by the uplink data is located and the narrowband offset information; and
when receiving the first downlink control information from the network device, the transceiver unit is configured to:
descramble the CRC of the first downlink control information by using the scrambling code, to obtain the first downlink control information.

20. The terminal device according to claim 13, wherein a quantity of bits comprised in the first bit is the same as a quantity of physical resource blocks occupied by the uplink data, and when the quantity of physical resource blocks occupied by the uplink data is greater than 1, the bits comprised in the first bit have a same value.
